(19) United States
(12) Patent Application Publication
(10) Pub. No.: US 2009/0279018 A1
(43) Pub. Date: Nov. 12, 2009

(54) Optical device having light diffusing paper incorporated therewith

(76) Inventor: Ching-Bin Lin, Taipei (TW)

Correspondence Address: Ching-Bin Lin, P.O. Box 55-846, Taipei, 104, TW

(21) Appl. No.: 12/151,493

(22) Filed: May 8, 2008

(51) Int. Cl. G02F 1/1335; G02B 5/02

(52) U.S. Cl. 349/64; 359/599

(57) ABSTRACT

An optical device includes a light diffusing paper as integrally formed, secured, bonded or adhered to a surface of an optical element, which includes: an optical film, a brightness enhancement film (BEF), a display, a light guide, to thereby form an optical device with increased light uniformity.

### BACKGROUND OF THE INVENTION

U.S. Pat. No. 7,218,450 disclosed a light diffusing film, adapted to be used in display device or LCD backlight system, and having a light diffusing layer (C) consisting of organic or inorganic light diffuser particles (S) and a binder resin (B) on a base (F) made of polymeric resin film.

However, such a prior art has the following drawbacks:
1. The light diffusing film includes a light diffusing layer (C) and a base layer (F), which may be delaminated when subjected to heat attack or stress by external forces to thereby deteriorate its quality and functions.
2. As illustrated in the drawing figures of the prior art, its base (F) is flat and may be easily secured or adhered on an optical element. However, its top surface is corrugated as caused by the diffuser particles (Sa, Sb, S) to be difficultly stably secured to a bottom surface of an optical element by such an irregular corrugated surface, thereby limiting its uses in the optical devices.

The present inventor has found the drawbacks of the prior art and invented the present optical device incorporated with light diffusing paper.

### SUMMARY OF THE INVENTION

The object of the present of the present invention is to provide an optical device including a light diffusing paper as integrally formed, secured, bonded or adhered to a surface of an optical element, which includes: an optical film, a brightness enhancement film (BEF), a display, a light guide, to thereby form an optical device with increased light uniformity.

### BRIEF DESCRIPTION OF THE DRAWINGS

FIG. 1 is a sectional drawing of the present invention.

FIG. 2 shows another preferred embodiment of the present invention as modified from FIG. 1.

FIG. 3 shows an optical device by forming a prismatic film on the light diffusing paper in accordance with the present invention.

FIG. 4 is an illustration showing that the light diffusing paper may be formed on an upper flat surface of the optical element in accordance with the present invention.

FIG. 5 shows a backlight module made by interposing a light diffusing paper in between a light guide and a LCD display in accordance with the present invention.

FIG. 6 shows another optical device having the prismatic film formed on a light diffusing paper, and interposed between the light guide and the LCD display in accordance with the present invention.

### DETAILED DESCRIPTION

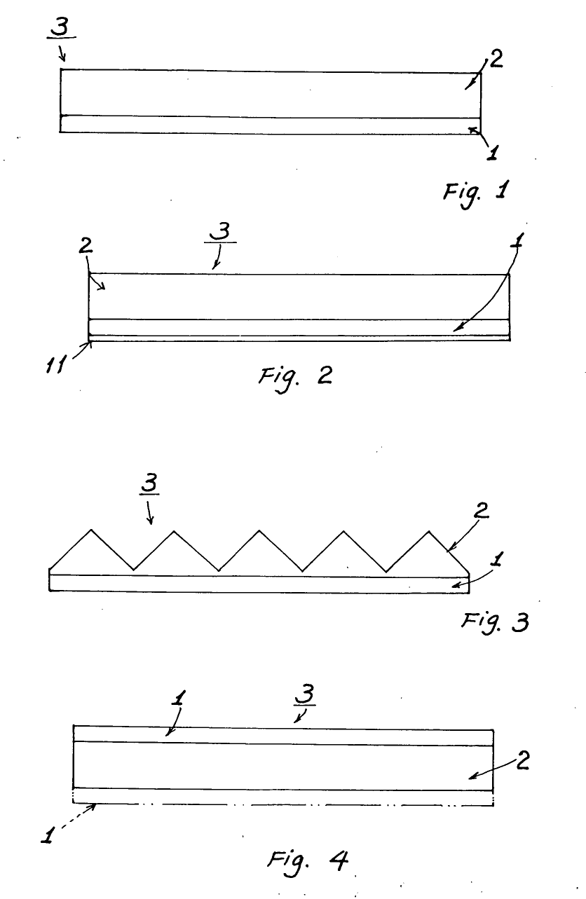

As shown in FIG. 1, an optical device 3 of the present invention comprises: a light diffusing paper 1 and an optical element 2 formed, fastened or adhered with the light diffusing paper 1.

The light diffusing paper 1 includes fibers homogeneously dispersed in a binder to form a translucent paper having a haze value ranging 10-85%, but not limited in the present invention.

The binders may be selected from: polyvinyl alcohol, polymers, inorganic sol, starch, gum, and other inorganic or organic binders.

The fibers may be selected from organic or inorganic fibers, cellulose fiber, pulp fibers, and synthetic fibers, such as: poly (phenylene terephthal amide) fiber, polyethylene glycol terephthalate fiber, etc.

The light diffusing paper 1 may be selected from tracing paper or drawing paper, which is available in the market.

The light diffusing paper 1 may include light scattering materials added therein to provide its light diffusing property.

The light diffusing paper 1 may be integrally formed with the optical element 2 by any conventional processes.

The light diffusing paper 1 may be adhered or bonded to the optical element 2 by adhesive or by other joining methods.

The light diffusing paper 1 may further include water-proof materials added therein for resisting water or moisture, if necessarily.

The optical element 2 is selected from the group consisting of: an optical film, a brightness enhancement film, a prismatic film, a light guide, a display, a LCD display, an optical sheet or plate, etc.

As shown in FIG. 3, the optical element 2 is a prismatic film (or layer) formed on the light diffusing paper 1.

As shown in FIG. 2, a protective layer 11 for anti-static, anti-warping and water-resistant properties is formed on a bottom or outermost surface of the light diffusing paper 1 for well protecting the paper.

As shown in FIG. 4, the light diffusing paper 1 may also be formed on an upper surface of the optical element 2; or the light diffusing paper 1 formed on both upper surface and bottom surface (dotted line shown) of the optical element 2, to form another preferred embodiment of the present invention.

By forming the light diffusing paper 1 to or with the optical element 2, the optical device 3 will increase its light uniformity as effected by the light diffusing paper 1 in addition to its optical properties including brightness.

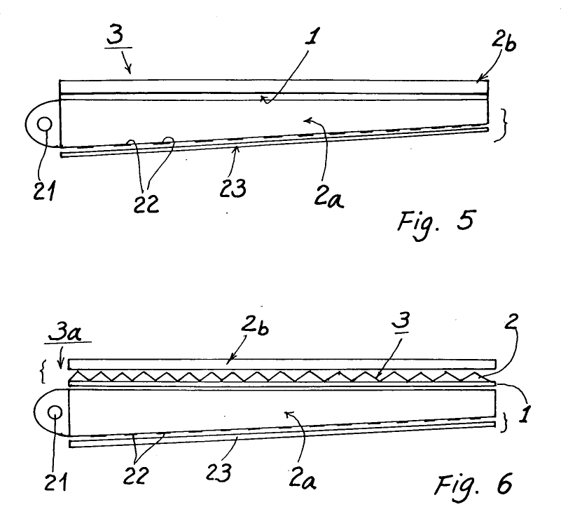

The light diffusing paper 1 may also be incorporated into an optical system or device, such as a backlight module or system as shown in FIGS. 5 and 6.

In FIG. 5, a light diffusing paper 1 is interposed in between a light guide 2a (a first optical element) and a LCD display 2b (a second optical element) of a backlight module 3.

The light guide 2a includes a light source 21, a plurality of dots 22 formed on (or in) a bottom portion of the light guide 2a, and a reflector 23 formed adjacent to the bottom of the light guide 2a. However, such a light guide is so conventional and not forming a part of this invention.

In FIG. 6, an optical device 3, which is an optical film including a light diffusing paper 1 integrally formed with a prismatic film (or layer) 2, is interposed in between a light guide 2a and a LCD display 2b, to thereby form another backlight module 3a.

Other optical devices 3 may be obtained by forming at least one light diffusing paper I with at least one optical element 2 to furnish the light diffusibility as effected by the light diffusing paper 1 of the optical device, thereby enhancing their light uniformity.

The present invention may be further modified without departing from the spirit and scope of the present invention.

1. An optical device comprising: a light diffusing paper and an optical element including an optical film, a light guide and a display formed, fastened or adhered on or with the light diffusing paper; the improvement which comprises:
said light diffusing paper being a light diffusing tracing paper or drawing paper.

2-14. (canceled)
